(19) United States
(12) Patent Application Publication
(10) Pub. No.: US 2006/0147195 A1
(43) Pub. Date: Jul. 6, 2006

(54) Mobile system with cameras, camera suspension, method for measuring camera location information, and camera mounting apparatus

(76) Inventors: Eul Gyoon Lim, Daejeon-city (KR); Dae Hwan Hwang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/293,288

(22) Filed: Dec. 1, 2005

(30) Foreign Application Priority Data
Dec. 7, 2004 (KR) 10-2004-0102475
Oct. 20, 2005 (KR) 10-2005-0099030

(51) Int. Cl. G03B 17/00

(52) U.S. Cl. 396/427

(57) ABSTRACT

A mobile system with cameras, a camera suspension, a method for measuring camera location information, and a camera mounting apparatus are provided. The mobile system with cameras comprising a camera mounting apparatus, the camera mounting apparatus includes a camera mounting unit which cameras join, a main body mounting unit attached to a main body of the mobile system; and connecting units for connecting the camera mounting unit with the main body mounting unit at a predetermined fixed point on one plane of the camera mounting unit, the connecting unit having an elastic unit and a damping unit for isolating the cameras from the movement of the main body mounting unit. The camera suspension can prevent the pictured moving image from severely shaking. In addition, the camera mounting plane information can be output to provide the camera location information in a real time. Therefore, the mobile system can obtain available image data during moving.

### CROSS-REFERENCE TO RELATED APPLICATION

This application claims priority to and the benefit of Korean Patent Applications Nos. 10-2004-0102475&10-2005-0099030 filed in the Korean Intellectual Property Office on Dec. 7, 2004 & Oct. 20, 2005 the entire contents of which are incorporated herein by reference.

### BACKGROUND OF THE INVENTION

(a) Field of the Invention

The present invention relates to a mobile system with cameras, a camera suspension, a method for measuring camera location information, and a camera mounting apparatus.

(b) Description of the Related Art

A moving object, such as a robot, fails to have a sufficient damping apparatus between the wheels and the body in spite of having the wheels in comparison with the vehicle. When the robot moves on uneven ground, the roughness of the uneven ground is directly transmitted to the robot so that the robot is tilted relative to the ground at every instance according to the roughness.

Generally, the robot may include an ultrasonic sensor or an infrared sensor, which is sensitive to a distance of an obstacle. These distance sensors are not sensitive to a small change of angle and so the actual distance is not significantly different from a distance measured by the tilted robot. That is, a small pose change of the robot does not affect the obstacle-detecting sensor.

However, when the robot consecutively photographs surrounding images through a video cameras mounted thereto and recognizes its position and an obstacle through the pictured surrounding images, it is difficult to analyze the image because the pose change of the robot changes the cameras view direction and viewpoint so that input subject image may be greatly changed. In addition, when the cameras, particularly an inexpensive interlace-type cameras, is subjected to extreme movement, the pictured image may become blurred and be impossible to process. In addition, when the robot has legs, the above-noted problems extensively occur whenever the robot walks.

Accordingly, a mobile system in which a cameras is mounted to a moving object, has to limit a speed, or stop a movement, so as to take an image, or alternatively have a plurality of sensors in addition to a vision system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a mobile system including cameras, a camera suspension, a method for measuring camera location information, and a camera mounting apparatus having advantages of preventing a movement of the mobile system from directly transmitted to the cameras, or minimizing the movement, thereby obtaining image information to be analyzed by a general cameras.

An exemplary mobile system including cameras according to an embodiment of the present invention includes a camera mounting apparatus including a camera mounting unit which cameras joins, a main body mounting unit attached to a main body of the mobile system, and connecting units for connecting the camera mounting unit with the main body mounting unit at a predetermined fixed point of the camera mounting unit, the connecting unit having an elastic unit for preventing the movement of the main body mounting unit from directly transmitted to the cameras.

An exemplary method for measuring camera location information in a mobile system including a camera mounting apparatus for mounting cameras to a main body thereof according to an embodiment of the present invention includes: a) obtaining fixed point information based on first, second, and third distance information, wherein the first, second, and third distance information correspond to distances from the fixed point on the camera mounting apparatus to the respective first, second, and third points on the main body mounting unit; and

b) obtaining the plane information of the camera mounting unit from the fixed point information and obtaining camera location information.

In addition, an exemplary camera suspension according to an embodiment of the present invention includes an elastic unit for isolating the cameras from the movement of the main body mounting unit so that it connects a camera mounting unit with a main body mounting unit of a mobile system at a predetermined fixed point of the camera mounting unit.

Further, an exemplary camera mounting apparatus for mounting cameras to a main body of a mobile system according to an embodiment of the present invention includes: a camera mounting unit which the cameras join; a main body mounting unit attached to a main body of the mobile system; and connecting units for connecting the camera mounting unit with the main body mounting unit at a predetermined fixed point of the camera mounting unit. The connecting unit may have an elastic unit and a damping unit for preventing the movement of the main body mounting unit from directly transmitted to the cameras.

### BRIEF DESCRIPTION OF THE DRAWINGS

FIG. 1 schematically illustrates an entire configuration of a mobile system according to an exemplary embodiment of the present invention.

FIG. 2 schematically illustrates an entire configuration of a camera suspension according to an exemplary embodiment of the present invention.

FIG. 3 shows a length sensor and mounting unit of a camera suspension according to an exemplary embodiment of the present invention.

FIG. 4 schematically illustrates an entire view of a camera mounting apparatus according to an exemplary embodiment of the present invention.

FIG. 5 illustrates a method for measuring a coordinate of a predetermined fixed point in a camera mounting plane according to an exemplary embodiment of the present invention.

FIG. 6 illustrates a method for measuring a camera mounting plane formula according to an exemplary embodiment of the present invention.

FIG. 7A and FIG. 7B illustrate a side and a bottom surface of a camera mounting apparatus including cameras according to an exemplary embodiment of the present invention.

FIG. 8 illustrates a method for measuring camera location information according to an exemplary embodiment of the present invention.

### DETAILED DESCRIPTION OF THE EMBODIMENTS

Exemplary embodiments of the present invention will hereinafter be described in detail with reference to the accompanying drawings.

Hereinafter, a mobile system, a camera location information measuring method in a mobile system, a camera suspension, and a camera fixing apparatus according to exemplary embodiments of the present invention are described in detail with reference to the accompanying drawings.

In addition, for convenience of description of a mobile system according to the exemplary embodiments of the present invention, a robot is exemplarily described. However, the scope of the present invention is not limited only to a robot.

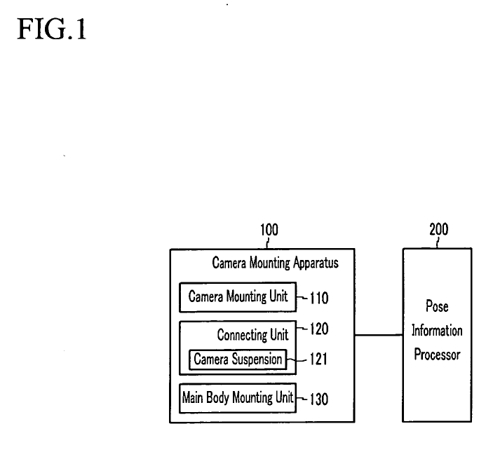

As shown in FIG. 1, a mobile system according to an exemplary embodiment of the present invention includes a camera mounting apparatus 100 and a pose information processor 200.

The camera mounting apparatus 100 mounts cameras to a main body and isolates the cameras from the movement of the main body, and also provides distance information between a predetermined fixed point of a camera mounting plane and a predetermined point of a main body mounting plane.

In more detail, the camera mounting apparatus 100 includes a camera mounting unit 110 which the cameras join, a main body mounting unit 130 mounted with respect to the main body, and connecting units 120 for connecting the camera mounting unit 110 with the main body mounting unit 130 at a predetermined fixed point on the camera mounting plane and preventing the movement of the main body from directly transmitted to the cameras using an elastic unit and a damping unit. In addition, the connecting unit 120 includes a camera suspension 121 for connecting the fixed point with three or more points of the main body mounting unit 130.

The pose information processor 200 obtains the distance information from the camera mounting apparatus 100 and sequentially estimates coordinates for the predetermined fixed points and a camera mounting plane formula based on the obtained distance information and obtains relative location information of the cameras with respect to the main body.

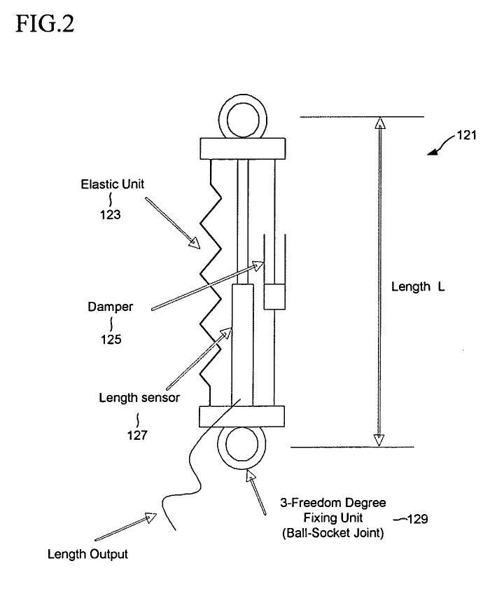

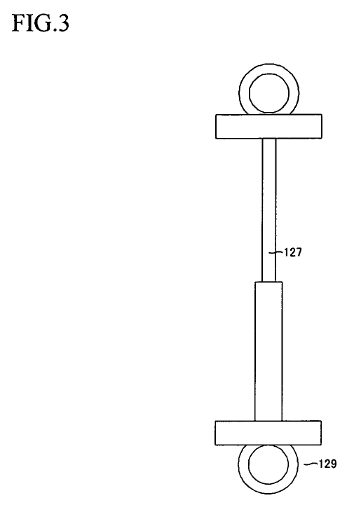

As shown in FIG. 2 and FIG. 3, the camera suspension 121 according to an exemplary embodiment of the present invention includes an elastic unit 123, a damping unit 125, a length sensor 127, and a fastening unit 129.

The elastic unit 123 includes an elastic material, such as a spring, and suppresses the movement of the main body of the mobile system applied to the cameras.

The damping unit 125 suppresses a relative movement, a vibration, and a resonance caused by the elastic unit 123. The damping unit 125 may be a viscously hydraulic damping unit including a cylinder having a viscous fluid, a diaphragm plate having a hole and reciprocating in the cylinder, and a rod connected to the diaphragm plate.

The fastening unit 129 mounts the elastic unit 123, the damping unit 125, and the length sensor 127 to the target, and in particular, it enables the elastic unit 123, the damping unit 125, and the length sensor 127 to freely move relative to the mounting position using, for example, a ball-socket joint.

The length sensor 127 outputs the length of the elastic unit 123 and damping unit 125. The length sensor 127 may include a potentiometer, such as a variable resistance apparatus, or a linear scalier.

Meanwhile, a moving robot may undergo a left/right rolling, a front/rear pitching, and a top/bottom bouncing due to a height difference of a contacted ground. The cameras are mounted at a convenient position for observing the surroundings. Accordingly, it is subject for the cameras to shake left/right or front/rear according to the rolling and pitching of the robot.

Accordingly, the suspension must have 5-freedom degrees for rolling, pitching, bouncing, and left/right and front/rear shaking so as to minimize the shaking of the cameras on the moving object.

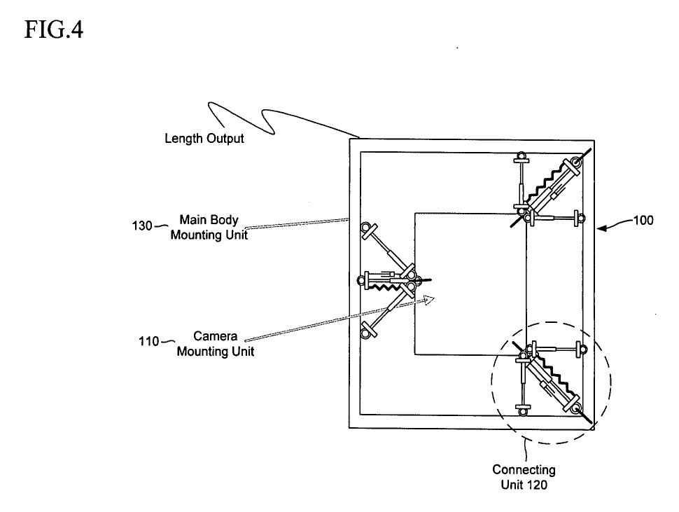

FIG. 4 illustrates a camera mounting apparatus 100 including a camera mounting unit 110, connecting units 120, and a body mounting unit 130, attached to a main body of a mobile system.

The cameras mounting unit 110 is a part to which cameras are joined, and is supported by the connecting units 120 at 3 or more points of the body-mounting unit 130 such that the cameras can freely move on the mobile system, such as a robot.

The connecting unit 120 includes the camera suspension 121 and the length sensor.

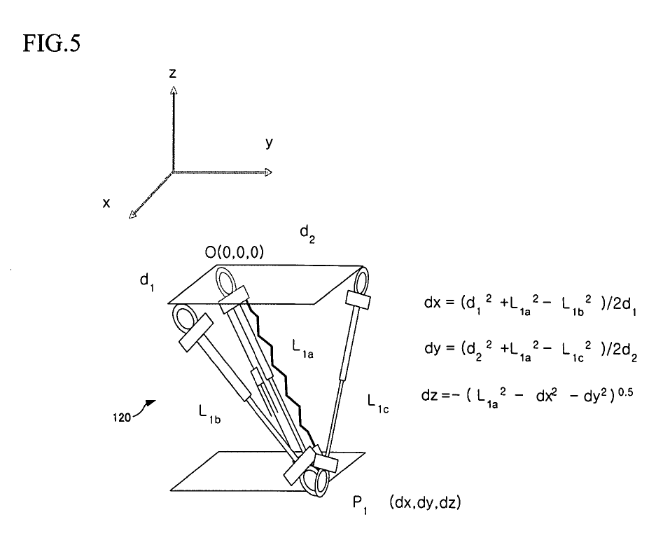

FIG. 5 illustrates a method for measuring a coordinate of a predetermined fixed point in a camera mounting plane according to an exemplary embodiment of the present invention. As shown in FIG. 5, P₁ is a point on the camera mounting unit 110 to which the camera suspension 121 is fixed and has 3-freedom degrees in a space. Accordingly, the location of P₁ can be given through distances from 3 predetermined points. At this time, the 3 predetermined points may indicate points apart from O (0, 0, 0) along an x-axis by d1 and along a y-axis by d2.

At this time, the distance (L₁ₐ) from P₁ to O can be extracted from the outputs of the length sensor 127 of the camera suspension 121 and the other two points can be extracted from the outputs L_{1b}, L_{1c} of the length sensor of the connecting unit.

In addition, the d1, d2, L₁ₐ, L_{1b}, and L_{1c} values can be used for a simultaneous equation to obtain dx, dy, and dz values as x, y, and z coordinates of P₁. As a result, P₁ (dx, dy, dz) can be obtained.

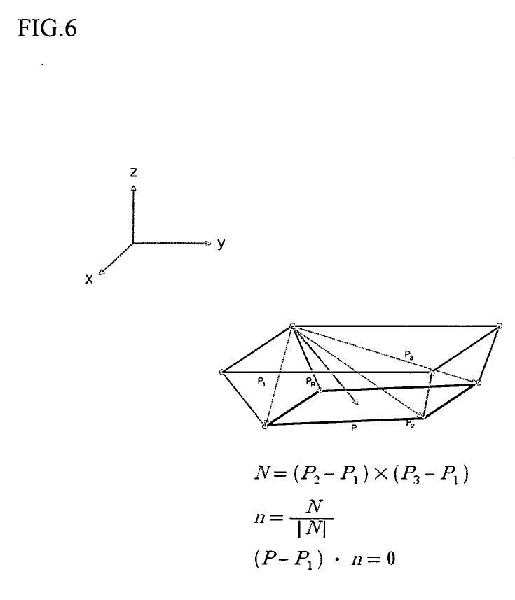

As shown in FIG. 6, in the above-described manner, coordinates P₁, P₂, and P₃ of 3 or more fixed points on the plane of the camera mounting unit 110 may be obtained and a plane equation of the camera mounting unit 110 may be obtained by using the fixed point coordinates P₁, P₂, and P₃.

A plane is defined as a set of points P satisfying ((P−P₁)·n=0), i.e., a condition that a dot product of two vectors is 0, wherein one vector n being vertical to the plane and the other vector being formed with a predetermined P and one point on the plane. The vector n is defined by a cross product (N=(P₂−P₁)_{X}(P₃−P₁)) of two vectors, wherein the two vectors are formed with a predetermined three points not linearly located on the plane

In addition, the vector n may be a unit direction vector

$$( n = \frac{N}{\vert N \vert} )$$

of the vector N.

The relative pose information of the camera mounting unit 110 to the system body mounting unit 130 may be obtained using the plane P formula of the camera mounting unit 110 and the fixed points (P₁, P₂, and P₃, or the like) on the plane. Therefore, the coordinates of the camera mounting unit 110 can be used as the mounted camera location and view point information by being transformed into an absolute coordinate system.

In more detail, when the main body mounting unit 130 has a 300 mm×200 mm size, the camera mounting unit 110 has 200 mm×100 mm size, and the respective edges of the main body mounting unit 130 has coordinates Q₁, Q₂, Q₃, and Q₄, the coordinate system may be established as follows.
Q1=(−150, −100, 0)
Q2=(150, −100, 0)
Q3=(150, 100, 0)
Q4=(−150, 100, 0)

When Qₙ (n=1, 2, 3, 4) of the main body mounting unit 130 are connected with points Pₙ (n=1, 2, 3, 4) on the camera mounting unit 110 through the camera suspension 121, the (d1, d2) of the connecting unit 120 mounted to P₁ and predetermined length output values (L₁ₐ, L_{1b}, and L_{1c}) may be assumed as follows.
(d1, d2)=50 and 50
(L₁ₐ, L_{1b}, L_{1c})=(90.6517, 68.6350, 85.4602)

At this time, by the above noted formula, the relative coordinates of P₁ to Q₁ are obtained as (60.0697, 34.1429, −58.6824). When the relative coordinates (60.0697, 34.1429, −58.6824) are transformed into the coordinate system of Q₁, the absolute coordinates (−89.9303, −65.8517, −58.6824) of P₁ are obtained.

Likewise, the (d1, d2) of the connecting unit 120 mounted to P₂ and predetermined length output values (L₁ₐ, L_{1b}, and L_{1c}) and may be assumed as follows.
(d1, d2)=50 and 50
(L₁ₐ, L_{1b}, L_{1c})=(100.1666, 75.1406, 90.7551)

At this time, by the above noted formula, the relative coordinates (60.0697, 34.1429, −58.6824) of P₂ to Q₂ are obtained. In addition, when the relative coordinates of P₂ transforms in a rectangular to z-axis and the transformed values are added to the Q₂ so as to transform this point into the coordinate system of Q₁, the absolute coordinates (107.0313, −31.1275, −58.6824) of P₂ are obtained.

Continually, (d1, d2) of the connecting unit 120 mounted to P₃ and the predetermined length output values, (L₁ₐ, L_{1b}, and L_{1c}) may be assumed as follows.
(d1, d2)=50 and 50
(L₁ₐ, L_{1b}, L_{1c})=(80.5062, 54.5369, 74.6121)

At this time, by the above noted formula, the relative coordinates (60.0697, 34.1429, −41.3176) of P₃ to Q₃ are obtained. In addition, when the relative coordinates of P₃ transforms in a rectangular to z-axis and the transformed values are added to Q₃ in order to transform this point into the coordinate system of Q₁, the absolute coordinates (89.9303, 65.5871, −41.3176) of P₃ are obtained.

In addition, the (d1, d2) of the connecting unit 120 mounted to P₄ and the predetermined length output values, (L₁ₐ, L_{1b}, and L_{1c}) may be assumed as follows.
(d1, d2)=50 and 50
(L₁ₐ, L_{1b}, L_{1c})=(91.0872, 62.5270, 80.6226)

At this time, by the above noted formula, the relative coordinates (68.8725, 42.9687, −41.3176) of P₄ to Q₄ are obtained. In addition, when the relative coordinates of P₄ transforms in a rectangular to z-axis and the transformed values are added to Q₄ in order to transform this point into the coordinate system of Q₁, the absolute coordinates (−107.0313, 31.1275, 41.3176) of P₄ are obtained.

The points P₁, P₂, P₃, and P₄ on the plane of the camera mounting unit 110 are obtained in this manner, and the plane formula formed with these points is calculated as follows.
P₁P₂=P₂−P₁=(196.9616, 34.7296, 0)
P₁P₃=P₃−P₁=(179.8605, 131.7143, 17.3648)
N=(P₂−P₁)ₓ(P₃−P₁)=(603, −342, 19696)
n=N/|N|=(0.0302, −0.1710, 0.9848)
(P−(−89.9303, −65.8571, −58.6824)) [symbol] (0.0302, −0.1710, 0.9848)=0
0.0302(x+89.9303)−0.1710(y+65.8571)+0.9848(z+58.6824)=0

That is, the plane formula is calculated from three points such as P₁, P₂, and P₃. When P₄ substitutes for the plane formula, 4.8010*10−5 can be obtained, which is approximately 0. That is, P₄ satisfies the plane formula.

The plane formula corresponds to the relative coordinate system with respect to the main body mounting unit 130. Therefore, the plane formula corresponds to the absolute coordinate system by transforming the vector n and P₁ so that it may be used as the camera viewpoint and view information.

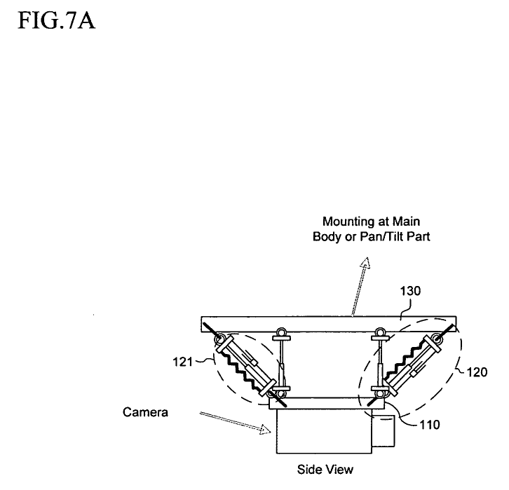

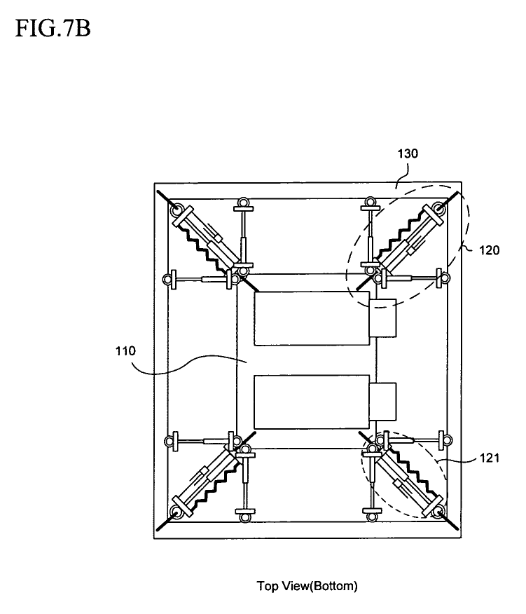

FIG. 7A and FIG. 7B illustrate a side and a bottom surface of a camera mounting apparatus including cameras according to an exemplary embodiment of the present invention.

That is, the camera mounting apparatus 100 including the camera mounting unit 110, the main body mounting unit 130, and the connecting unit 120 can mount the camera mounting unit 110 to the main body mounting unit 130 using four fixed points.

At this time, as shown in FIG. 7A and FIG. 7B, the camera mounting unit 110 may be fixed to the main body mounting unit 130 using only 3 fixed points for configuring a plane.

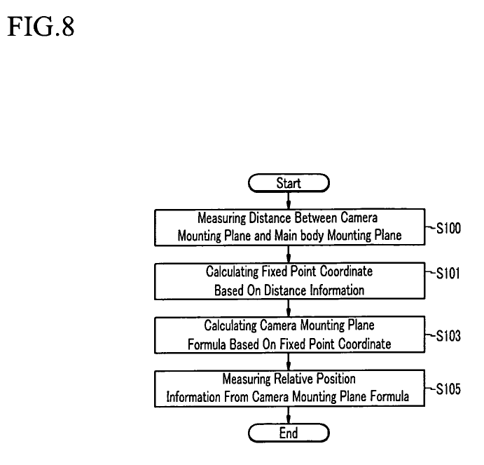

Hereinafter, a method for measuring camera location information according to an exemplary embodiment of the present invention is described in detail with reference to FIG. 8.

First of all, a first distance, a second distance, and a third distance are measured by the length sensor included in the connecting unit 120, which respectively correspond to distances from the fixed point on the plane of the camera mounting unit 110 to the first point, the second point, and the third point of the main body mounting unit. At this time, the length sensor included in the camera suspension 121 may measure the distance between the fixed point on one plane of the camera mounting unit and the first point (S100).

For example, when the first point is assumed as O point and the second point as the point apart from the first point along the x-axis by d1 and the third point as the point apart from the first point along the y-axis by d2, the coordinates of the fixed point P1 can be extracted from the first distance, the second distance, the third distance, d1, and d2 in the above-noted manner (S101).

The coordinates of the predetermined fixed points P2 and P3 on one plane of the camera mounting unit 110 can be extracted in the same manner, and the plane formula of the camera mounting unit 110 can be extracted from three or more fixed points such as P1, P2, and P3, etc., not linearly located on the plane (S103).

As a result, the relative location information of the cameras with respect to the main body can be obtained since the relative position information of the cameras to the main body can be obtained through the coordinates of the fixed point on one plane of the camera mounting plane and the plane formula (S105).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an embodiment of the present invention, the camera suspension can prevent the pictured moving image from severely shaking. In addition, according to an embodiment of the present invention, the camera mounting plane information can be output to provide the camera location information in a real time. Therefore, the mobile system can obtain available image data during moving.

What is claimed is:

1. A mobile system with a camera comprising a camera mounting apparatus, the camera mounting apparatus including:
a camera mounting unit which at least a camera is mounted;
a main body mounting unit attached to a main body of the mobile system; and
connecting units for connecting the camera mounting unit with the main body mounting unit at a predetermined fixed point on one plane of the camera mounting unit.

2. The mobile system of claim 1, wherein the connecting unit includes a length sensor for respectively measuring first, second, and third distances from the fixed point to the respective first, second, and third points of the main body mounting unit.

3. The mobile system of claim 2, wherein the connecting unit includes an elastic unit and a damping unit for preventing the movement of the main body mounting unit from directly transmitted to the cameras.

4. The mobile system of claim 2, wherein the elastic unit and the damping unit form a camera suspension for connecting the fixed point with a first point of the main body mounting unit.

5. The mobile system of claim 4, wherein the damping unit suppresses relative movement and vibration of the elastic unit.

6. The mobile system of claim 2, wherein the camera suspension includes a 3 freedom degree fastening unit fixed at the fixed point.

7. The mobile system of claim 1 further comprising a pose information processor, the pose information processor obtaining the fixed point information based on first, second, and third distance information, wherein the first, second, and third distance information are transmitted from the length sensor, obtaining the plane information of the camera mounting unit from the fixed point information, and obtaining relative pose information of the camera mounting unit with respect to the main body mounting unit.

8. The mobile system of claim 7, wherein the pose information processor obtains the plane information of the camera mounting unit through three or more fixed point information and extracts the relative pose information using a plane formula and coordinates of the fixed points.

9. The mobile system of claim 8, wherein
the second point and the third point respectively correspond to points apart from the first point by d1 along an x-axis and by d2 along a y-axis,
the fixed point information are extracted from the first distance, the second distance, the third distance, d1, and d2 information.

10. The mobile system of claim 9, wherein the fixed point information (dx,dy,dz) are extracted from:
dx=(d₁²+L₁ₐ²−L_{1b}²)/2d₁
dy=(d₂²+L₁ₐ²−L_{1c}²)/2d₂
dz=−(L₁ₐ²−dx²−dy²)^{0.5},
where L₁ₐ is the first distance, L_{1b} is the second distance, and L_{1c} is the third distance.

11. The mobile system of claim 10, wherein the plane formula P is extracted from:
$$N = ( {P}_{2} - {P}_{1} ) \times ( {P}_{3} - {P}_{1} )$$
$$n = \frac{N}{\vert N \vert}$$
$$( P - {P}_{1} ) \cdot n = 0 ,$$
where P₁, P₂, P₃ are predetermined fixed points on one plane of the camera mounting unit,
N is a cross product of two vectors, the two vectors being formed with the predetermined three fixed points, and
n is a unit direction vector of vector N.

12. A camera suspension for connecting a camera mounting unit with a main body mounting unit of a mobile system at a predetermined fixed point on one plane of the camera mounting unit, comprising an elastic unit and a damping unit for preventing the movement of the main body mounting unit from directly transmitted to the cameras.

13. The camera suspension of claim 12, wherein the elastic unit connects the fixed point with a first point of the main body mounting unit.

14. The camera suspension of claim 12, wherein the damping unit suppresses relative movement and vibration of the elastic unit.

15. The camera suspension of claim 12, further comprising a length sensor for measuring a distance from the fixed point to the first point of the main body mounting unit.

16. The camera suspension of claim 12, further comprising a 3-freedom degree fastening unit fixed at the fixed point.

17. A camera mounting apparatus for mounting cameras to a main body of a mobile system, comprising:
a camera mounting unit which the cameras join;
a main body mounting unit attached to a main body of the mobile system; and
connecting units for connecting the camera mounting unit with the main body mounting unit at a predetermined fixed point on one plane of the camera mounting unit.

18. The camera mounting apparatus of claim 17, wherein the connecting unit includes a length sensor for measuring first, second, and third distances from the fixed point to the respective first, second, and third points.

19. The camera mounting apparatus of claim 17, wherein the connecting unit includes an elastic unit and a damping unit for preventing the movement of the main body mounting unit from directly transmitted to the cameras.

20. The camera mounting apparatus of claim 18, wherein the elastic unit and the damping unit form a camera suspension for connecting the fixed point with a first point of the main body mounting unit.

21. The camera mounting apparatus of claim 18, wherein the damping unit suppresses relative movement and vibration of the elastic unit.

22. The camera mounting apparatus of claim 18, wherein the camera suspension includes a 3-freedom degree fastening unit fixed at the fixed point.

23. A method for measuring camera location information in a mobile system including a camera mounting apparatus for mounting cameras to a main body thereof, the method comprising:
a) obtaining fixed point information based on first, second, and third distance information, wherein the first, second, and third distance information correspond to distances from the fixed point to the respective first, second, and third points; and
b) obtaining the plane information of the camera mounting unit from the fixed point information and obtaining camera location information.

24. The method for measuring camera location information of claim 23, wherein at a), three or more coordinates are obtained for three or more fixed points.

25. The method for measuring camera location information of claim 24, wherein at b), a plane formula of the camera mounting is extracted using three or more fixed point coordinates.

26. The method for measuring camera location information of claim 23, wherein the second point and the third point respectively correspond to points apart from the first point by d1 along an x-axis and by d2 along a y-axis, and the fixed point information are extracted from the first distance, the second distance, the third distance, d1, and d2 information.

27. The method for measuring camera location information of claim 26, wherein the fixed point information (dx,dy,dz) are extracted from:
dx=(d₁²+L₁ₐ²−L_{1b}²)/2d₁
dy=(d₂²+L₁ₐ²−L_{1c}²)/2d₂
dz=−(L₁ₐ²−dx²−dy²)^{0.5},
where L₁ₐ is the first distance, L_{1b} is the second distance, and L_{1c} is the third distance.

28. The method for measuring camera location information of claim 27, wherein the plane formula P is extracted from:
$$N = ( {P}_{2} - {P}_{1} ) \times ( {P}_{3} - {P}_{1} )$$
$$n = \frac{N}{\vert N \vert}$$
$$( P - {P}_{1} ) \cdot n = 0 ,$$
where P₁, P₂, P₃ are predetermined fixed points on one plane of the camera mounting unit,
N is a cross product of two vectors, the two vectors being formed with predetermined three fixed points, and
n is a unit direction vector of vector N.
